(19) United States
(12) Patent Application Publication
(10) Pub. No.: US 2008/0049556 A1
(43) Pub. Date: Feb. 28, 2008

(54) Playing card - hand protector and playing skill development device

(76) Inventor: Beaunos Pernell Smith, Jacksonville, FL (US)

Correspondence Address: Beaunos P. Smith, P.O. Box 2978, Jacksonville, FL, 32203-2978, US

(21) Appl. No.: 11/408,385

(22) Filed: Apr. 20, 2006

(51) Int. Cl. G04F 10/00

(52) U.S. Cl. 368/3

(57) ABSTRACT

A playing card hand protector (after cards are dealt from a playing card deck to individual players, the cards held by player (s) is considered a hand) skill development device with a programmed clock built-in, for timing, signaling, in the form of sound and lighting. The device also allows for data storage. It is rectangular in shape and similar to that of a standard size playing card. It's depth is approximately one-eighth to one quarter inch (⅛ to ¼), a rectangular body with an upper surface, a lower surface and a continuous sidewall. In addition, the product will consist of an on/off switch. The purpose of this product is to multi-functional. Specifically: 1) protect the integrity of the game 2) conceal the value of the hand 3) protect the hand from being mucked or called dead 4) improve playing skills through training, eg., teach player(s) to time his/her action(s) and reaction(s) while in play, thus minimizing other players ability to read the strength or weakness of the hand in play. Also, documenting the timing of sessions of play will give indication of players experience in playing. Generally, these purposes are associated with playing card games of poker. This device will be supported by an overall playing skill development program.

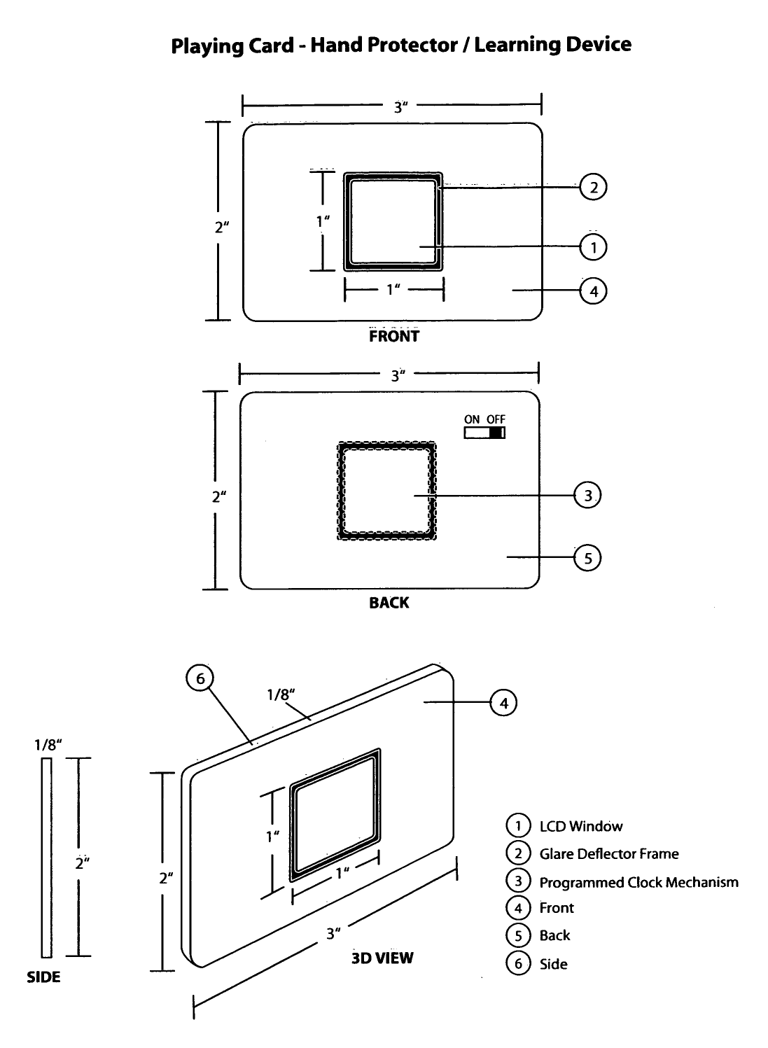

### BACKGROUND OF THE INVENTION

After having been exposed to the game of poker for many years, there became a recognized need for playing card hand protection. Additionally, there was a need for a medium of standardizing card playing skill development.

In the many games of poker, it is generally recommended and strongly suggested that players DO NOT hold their cards in their hand, instead they are to be placed face down on the playing surface. With the intent to minimize:
1) players ability to cheat, e.g., marking, switching, scratching and hiding cards, there Grew the need for cover, to further protect the integrity of the game.
2) hand be mucked or called dead, due to the mixing of another players hand.
3) opponent player(s) ability to view your hand.

Given the exposure and the heighten interest in the game of poker, it has come to the realization that there is a need for formal playing skills and some standardization for doing so, hence the playing card protection and development device is the vehicle for doing so. This device will be associated with an overall playing skill development program.

1. A playing card hand protector and playing skill development device designed to develop playing skills with a programmed clock contained within, for timing, signaling in the form of sound and lighting and data storage retention. The device will also have data transmission capability. A rectangular device consisting of an upper and lower surface, with continuous sidewall, a length, width and height. Mechanism will also contain an LCD display window with frame for glare and light deflection.

2. The device of claim 1 will contain a programmed clock that will time sessions of play.

3. The device of claim 1 will contain a programmed clock for the purpose of a player(s) timing his/her action(s) and reactions in play.

4. The device of claim 1 will contain a programmed clock mechanism that will have an additional function of signaling players in pre-set time intervals via lighting.

5. The device of claim 1 will contain a programmed clock mechanism that will signal via sound tone.

6. The device of claim 1 will contain a programmed clock mechanism that will have the capability of storing data applicable to stored timed sessions information.

7. The programmed clock mechanism will also have the capability of receiving data transmission(s), e.g. access codes.

8. The programmed clock mechanism of claim 7 will contain a feature that will store e.g., accumulative hours.

9. Incorporated into the programmed clock mechanism of claim 7 device will be an on switch that will activate clock.

10. Incorporated into the programmed clock mechanism of claim 7 will be an off switch will deactivate the clock.

12. The programmed clock mechanism of claim 7 will contain an alarm that will generate a sound tone.

13. The rectangular playing card shaped device of claim 1 will be approximately ⅛ to ¼ in depth and 3 inches in length and 2 inches in width.

14. The device of claim 7 will contain an LCD display window which will, at activation show a running clock

15. The LCD window display will also be utilized for timing actions and reactions in play.

16. The LCD window display of claim 15 will be approximately 1″ inch by 1″ inch with rounded corners.

17. The LCD window of claim 15 will have a Glare Deflection frame of approximately 1/16 inch in width on outer surface of window.

18. The playing card hand protector and playing skill development device of claim 1 will identify owner by player identification number(s) (PIN), either embossed on bottom surface or stored in programmed clock mechanism.
